(19) United States
(12) Patent Application Publication
(10) Pub. No.: US 2003/0062495 A1
(43) Pub. Date: Apr. 3, 2003

(54) Fluid control valve with low pressure drop ratio factor

(76) Inventors: Ted A. Long, Sugar Land, TX (US); Matthew William Hanusa, Albion, IA (US); David James Westwater, Albion, IA (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/219,716

(22) Filed: Aug. 15, 2002

Related U.S. Application Data
(60) Provisional application No. 60/313,251, filed on Aug. 17, 2001.

(51) Int. Cl. F16L 55/02

(52) U.S. Cl. 251/122; 251/360

(57) ABSTRACT

A fluid control valve, and a seat ring for use in a fluid control valve, have a low pressure drop ratio factor, lessening the pressure reduction across the operating valve. The low pressure drop ratio factor is achieved by modifying the seat ring inlet to form an entrance nozzle passage, which, in combination with a long, widening outlet passage, enables superior performance in valves incorporating the seat ring.

### CROSS-REFERENCE TO RELATED APPLICATIONS

This application claims priority to U.S. Provisional Application serial No. 60/313,251, entitled “Fluid Control Valve With Low Pressure Drop Ratio Factor,” filed Aug. 17, 2001.

### TECHNICAL FIELD

This invention relates to fluid flow control valves and in particular to fluid flow control valves having a very low pressure drop ratio factor.

### BACKGROUND

Fluid flow control valves are in common use in gas pipeline systems, chemical processing plants, etc. for accurately controlling the flow of fluid in such systems. At times there is a requirement for a fluid flow control valve having very low pressure drop ratio factor characteristics such that the valve can be operated with a maximum (or choked) fluid flow wherein the flow will always be proportional to the valve stem position.

Attempts have been made in the past to obtain a control valve with a low pressure drop ratio factor by adjusting the valve structure at the exit side of the valve, i.e., the downstream side of the valve after the valve throttling area. Such prior attempts have resulted in reducing the pressure drop ratio factor from about 0.73 to about 0.28. However, it is desired in certain instances to provide a fluid flow control valve having a very low pressure drop ratio factor, such as a pressure drop ratio factor below 0.14.

### SUMMARY OF THE INVENTION

A fluid flow control valve constructed in accordance with the principles of the present invention includes a valve body having a fluid inlet and a fluid outlet and a flow passageway communicating fluid therebetween. A seat ring is mounted within the flow passageway and cooperates with a valve stem and plug to control the fluid flow between the top orifice of the seat ring and the valve outlet.

The seat ring includes three different internal passageways for communicating the fluid flow through the seat ring, namely: (1) an upper angled portion extending from the upper seat orifice and downwardly convergingly angled within the seat valve; (2) a middle, substantially cylindrical passageway; and (3) a lower, divergent outwardly passageway extending towards the valve output. An elongated, contoured plug is provided for engaging the seat ring within the upper angled portion to control the fluid flow.

It has been determined to be especially advantageous, for such a valve requiring a very low pressure drop ratio factor, to include a gradually tapered, entrance nozzle structure for the fluid flowing from the valve passageway into the valve seat and leading into the area of the valve seat where flow throttling is occurring. In particular, it is especially advantageous to include the most efficient nozzle structure by converting fluid enthalpy into kinetic energy in as efficient a way as possible, similar to a converging -diverging or “de Laval” nozzle structure.

In a constructed prototype angle globe valve embodiment of the invention, with an entrance nozzle structure provided in accordance with the principles of the present invention between an angled seat and a contoured plug, a desired low pressure drop ratio factor of about 0.065 was achieved.

### BRIEF DESCRIPTION OF THE DRAWINGS

The invention may be best understood by reference to the following description taken in conjunction with the accompanying drawings, in which like reference numerals identify like elements in the several figures and in which:

FIG. 1 is a sectional view of a fluid flow control valve with a very low pressure drop ratio factor in accordance with the present invention; and

FIG. 2 is an exploded view incorporating the valve seat and plug components of the control valve of FIG. 1.

### DETAILED DESCRIPTION

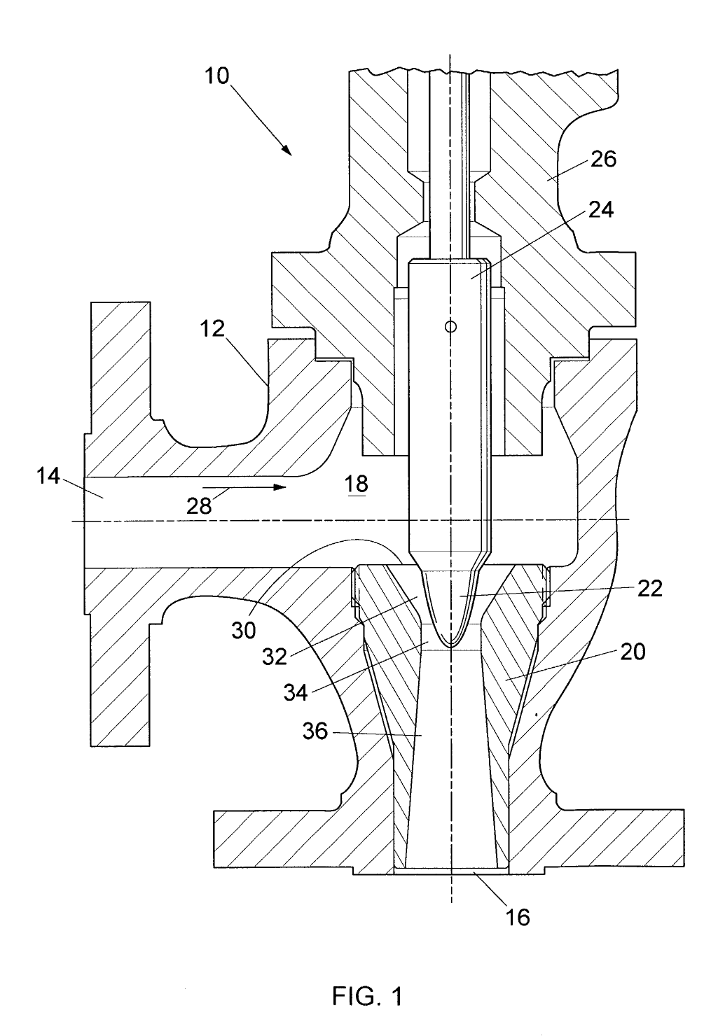

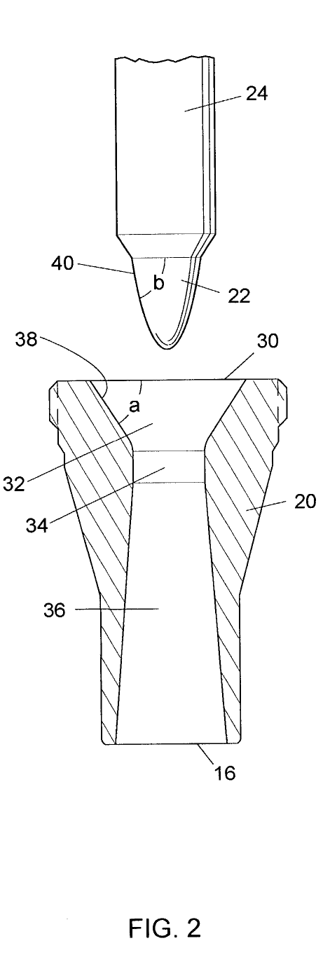

FIGS. 1 and 2 illustrate one embodiment of the invention in which an angled globe valve has been provided with a very low pressure drop ratio factor. It is to be understood that the present description is for purposes of illustrating the present invention and the principles herein may be applied to other types of valves as well.

With reference to FIGS. 1 and 2, there is illustrated a fluid flow control valve 10 including a valve body 12 having a fluid inlet 14, a fluid outlet 16, and an inner connecting passageway 18 for communicating fluid from the inlet 14 through the valve body 12 and to the outlet 16. Within the valve body 12 there is mounted a hollow seat ring 20. A valve plug 22 cooperates with the seat ring 20 to control the flow of fluid between the valve inlet 14 and the valve outlet 16. The plug 22 is formed integrally with a valve stem 24 which is slidably mounted within a valve bonnet 26, which in turn is suitably mounted to the valve body 12. In a known manner, the valve stem 24 can be suitably stroked to position the plug 22 into and away from a fluid sealing position within the seat ring 20 for controlling the fluid flow through the valve.

It is understood that the fluid flow is in the direction of arrow 28 such that the fluid flows from inlet 14 through the passageway 18, into the interior of the seat ring 20 and out the valve outlet 16. In accordance with the principles of the present invention, there is provided a gradually tapered, entrance nozzle structure for the fluid as the fluid traverses through an upper seat ring orifice 30 and into the interior of the seat ring. The seat ring 20 includes a series of hollow inner passageways, including an upper, angled passageway 32 extending from the seat ring orifice 30, a middle substantially cylindrical passageway 34, and a lower diverging outwardly passageway 36. The upper, angled passageway 32 is formed by downwardly converging seat surfaces 38 (in the shape of a cone) and extending at an angle a (see FIG. 2) from the horizontal top surface of the seat ring. Rather than the straight line seat surfaces 38 generating a cone, other surface configurations can be utilized under the teachings herein, such as a 5^{th} order polynomial, etc.

In accordance with the principles of the present invention, there is provided a gradually converging nozzle-like entrance for the fluid entering the plug and seat ring interface. This is accomplished by lowering the seat line into the seat ring and then shaping the inlet to create the nozzle.

Specifically, with reference to FIGS. 1 and 2, the upper angled passageway 32 is defined by gradually downwardly converging surfaces 38 and is made long enough to cooperate with the contoured plug 22 so that there is created a gradually tapered, entrance nozzle structure for the flow into the area where throttling is occurring between the surfaces 38 of the angled passageway 32 and the contoured exterior surfaces 40 of the plug 22. It is understood of course that the throttling area occurs at the minimum cross-sectional area between the seat surfaces 38 and the plug surfaces 40 within the angled passageway 32 of seat ring 20. This unique structure provides the flow control valve 10 with a very low pressure drop ratio factor such that the valve operates in the choked flow regime with as small a pressure change across the valve as possible in order that the mass flow rate at a given stem position will remain constant over a large range of pressure changes. The cooperation between the plug 22 and the angled passageway 32 provides a very efficient nozzle structure substantially characteristic of a “de Laval nozzle” or known simply as a “Laval nozzle” structure.

In a constructed prototype embodiment of an angle globe valve of the present invention, the seat ring 20 is provided with an angled passageway in which the angle a of the seat surfaces 38 (see FIG. 2) is about 57 degrees. The plug 22 of the constructed prototype embodiment includes an angle b of the exterior plug surface 40 (see FIG. 2) of about 60 degrees. With such a configuration, the constructed prototype embodiment valve exhibited a desired very low pressure drop ratio factor of about 0.065.

The foregoing detailed description has been given for clearness of understanding only, and no unnecessary limitations should be understood therefrom, as modifications will be obvious to those skilled in the art.

We claim:

1. A fluid control valve comprising:
a valve body having a fluid inlet, a fluid outlet, and a flow passageway disposed between the fluid inlet and the fluid outlet;
a seat ring disposed within the flow passageway, the seat ring including:
a seat ring inlet;
a seat ring outlet;
an intermediate passage;
an entrance nozzle passage connected between the seat ring inlet and the intermediate passage, the entrance nozzle passage including surfaces generally angled to converge from the seat ring inlet toward the intermediate passage, forming a narrowing passage, and the entrance nozzle passage being longer than the intermediate passage;
an outlet passage connected between the intermediate passage and the seat ring outlet, the outlet passage including surfaces generally angled to gradually diverge from the intermediate passage toward the seat ring outlet, forming a widening passage;
wherein the intermediate passage forms a transitional passage between the convergingly angled surfaces of the entrance nozzle passage and the divergently angled surfaces of the outlet passage; and
a valve plug adapted to seal the flow passageway, the valve plug including an exterior plug surface.

2. The fluid control valve of claim 1, wherein the valve plug cooperates with the entrance nozzle passage to seal the flow passageway at a seat line disposed between the entrance nozzle passage and the intermediate passage.

3. The fluid control valve of claim 1, wherein the entrance nozzle passage has a first aperture located at the seat ring inlet, and a second aperture located at the intermediate passage which is smaller than the first aperture; and wherein the area of the aperture of the entrance nozzle decreases between the seat ring inlet and the intermediate passage.

4. The fluid control valve of claim 1, wherein the entrance nozzle passage comprises linear angled sides.

5. The fluid control valve of claim 1, wherein the entrance nozzle passage comprises non-linear sides.

6. The fluid control valve of claim 1, wherein outlet passage comprises linear angled sides.

7. The fluid control valve of claim 1, wherein outlet passage comprises non-linear sides.

8. The fluid control valve of claim 1, wherein the outlet passage is longer than the intermediate passage.

9. The fluid control valve of claim 1, wherein the outlet passage is longer then the entrance nozzle passage.

10. The fluid control valve of claim 9, wherein the entrance nozzle passage and the outlet passage comprise linear angled sides.

11. The fluid control valve of claim 9, wherein the entrance nozzle passage and the outlet passage comprise non-linear sides.

12. The fluid control valve of claim 1, wherein the entrance nozzle passage and the outlet passage comprise linear angled sides.

13. The fluid control valve of claim 1, wherein the entrance nozzle passage and the outlet passage comprise non-linear sides.

14. The fluid control valve of claim 1, wherein the intermediate passage is substantially cylindrical.

15. The fluid control valve of claim 1, wherein the diameter of the intermediate passage is substantially constant.

16. The fluid control valve of claim 1, wherein the surfaces of the entrance nozzle passage form a seating surface angle of approximately 57 degrees with a plane perpendicular to a central axis of the seat ring.

17. The fluid control valve of claim 16, wherein the exterior plug surface of the valve plug forms a plug angle with a plane perpendicular to a central axis of the valve plug, wherein the plug angle is greater than the seating surface angle.

18. The fluid control valve of claim 17, wherein the plug angle is approximately 60 degrees.

19. A seat ring for use in a fluid control valve comprising:
a seat ring inlet;
a seat ring outlet;
an intermediate passage;
an entrance nozzle passage connected between the seat ring inlet and the intermediate passage, the entrance nozzle passage including surfaces generally angled to converge from the seat ring inlet toward the intermediate passage, forming a narrowing passage, and the entrance nozzle passage being longer than the intermediate passage;
an outlet passage connected between the intermediate passage and the seat ring outlet, the outlet passage including surfaces generally angled to gradually diverge from the intermediate passage toward the seat ring outlet, forming a widening passage; and
wherein the intermediate passage forms a transitional passage between the convergingly angled surfaces of the entrance nozzle passage and the divergently angled surfaces of the outlet passage.

20. The seat ring of claim 19, wherein the entrance nozzle passage has a first aperture located at the seat ring inlet, and a second aperture located at the intermediate passage which is smaller than the first aperture; and wherein the area of the aperture of the entrance nozzle decreases between the seat ring inlet and the intermediate passage.

21. The seat ring of claim 19, wherein the entrance nozzle passage comprises linear angled sides.

22. The seat ring of claim 19, wherein the entrance nozzle passage comprises non-linear sides.

23. The seat ring of claim 19, wherein seat ring outlet passage comprises linear angled sides.

24. The seat ring of claim 19, wherein seat ring outlet passage comprises non-linear sides.

25. The seat ring of claim 19, wherein the seat ring outlet passage is longer than the intermediate passage.

26. The seat ring of claim 19, wherein the seat ring outlet passage is longer then the entrance nozzle passage.

27. The seat ring of claim 26, wherein the seat ring entrance nozzle passage and the seat ring outlet passage comprise linear angled sides.

28. The seat ring of claim 26, wherein the seat ring entrance nozzle passage and the seat ring outlet passage comprise non-linear sides.

29. The seat ring of claim 19, wherein the seat ring entrance nozzle passage and the seat ring outlet passage comprise linear angled sides.

30. The seat ring of claim 19, wherein the seat ring entrance nozzle passage and the seat ring outlet passage comprise non-linear sides.

31. The seat ring of claim 19, wherein the intermediate passage is substantially cylindrical.

32. The seat ring of claim 19, wherein the diameter of the intermediate passage is substantially constant.

33. The seat ring of claim 19, wherein the surfaces of the entrance nozzle passage form a seating surface angle of approximately 57 degrees with a plane perpendicular to a central axis of the seat ring.
